(19) United States
(12) Patent Application Publication
(10) Pub. No.: US 2026/0173210 A1
(43) Pub. Date: Jun. 18, 2026

(54) TIMER-BASED RADIO FREQUENCY IDENTIFICATION OPERATION MANAGEMENT

(71) Applicant: QUALCOMM Incorporated, San Diego, CA (US)

(72) Inventors: Xinning SHEN, San Diego, CA (US); Rishav REJ, Pleasanton, CA (US); Uttam PATTANAYAK, San Diego, CA (US); Qingxin CHEN, San Diego, CA (US); Sheng-Yuan TU, San Diego, CA (US); Joseph Patrick BURKE, Carlsbad, CA (US)

(21) Appl. No.: 18/980,328

(22) Filed: Dec. 13, 2024

(51) Int. Cl. H04W 76/38; H04W 64/00

(52) U.S. Cl. CPC H04W 76/38; H04W 64/00

(57) ABSTRACT

In some implementations, a user equipment (UE) may obtain configuration information associated with an inactivity timer for radio frequency identification (RFID) communications, the configuration information indicating that the inactivity timer is to be stopped in accordance with an RFID operation being initiated and that the inactivity timer is to be restarted in accordance with the RFID operation being completed. The UE may start the inactivity timer based at least in part on executing an RFID application associated with performing the RFID communications. The UE may disable the RFID communications by the UE based at least in part on an expiration of the inactivity timer. Numerous other aspects are described.

### FIELD OF THE DISCLOSURE

Aspects of the present disclosure generally relate to wireless communication and, for example, to timer-based radio frequency identification operation management.

### BACKGROUND

Radio frequency identification (RFID) is a technology that uses electromagnetic fields to wirelessly transmit data between an RFID device and an RFID reader. An RFID device, such as an RFID tag, may include a microchip for storing data and an antenna for communicating with the RFID reader. RFID devices can be passive, relying on signals transmitted by the reader for power, or can be active, such as by being equipped with batteries for greater range and functionality.

### SUMMARY

Some aspects described herein relate to a method of wireless communication performed by a user equipment (UE). The method may include obtaining configuration information associated with an inactivity timer for radio frequency identification (RFID) communications, the configuration information indicating that the inactivity timer is to be stopped in accordance with an RFID operation being initiated and that the inactivity timer is to be restarted in accordance with the RFID operation being completed. The method may include starting the inactivity timer based at least in part on executing an RFID application associated with performing the RFID communications. The method may include disabling the RFID communications by the UE based at least in part on an expiration of the inactivity timer.

Some aspects described herein relate to an apparatus for wireless communication at a UE. The apparatus may include one or more memories and one or more processors coupled to the one or more memories. The one or more processors may be configured to obtain configuration information associated with an inactivity timer for RFID communications, the configuration information indicating that the inactivity timer is to be stopped in accordance with an RFID operation being initiated and that the inactivity timer is to be restarted in accordance with the RFID operation being completed. The one or more processors may be configured to start the inactivity timer based at least in part on executing an RFID application associated with performing the RFID communications. The one or more processors may be configured to disable the RFID communications by the UE based at least in part on an expiration of the inactivity timer.

Some aspects described herein relate to a non-transitory computer-readable medium that stores a set of instructions for wireless communication by a UE. The set of instructions, when executed by one or more processors of the UE, may cause the UE to obtain configuration information associated with an inactivity timer for RFID communications, the configuration information indicating that the inactivity timer is to be stopped in accordance with an RFID operation being initiated and that the inactivity timer is to be restarted in accordance with the RFID operation being completed. The set of instructions, when executed by one or more processors of the UE, may cause the UE to start the inactivity timer based at least in part on executing an RFID application associated with performing the RFID communications. The set of instructions, when executed by one or more processors of the UE, may cause the UE to disable the RFID communications by the UE based at least in part on an expiration of the inactivity timer.

Some aspects described herein relate to an apparatus for wireless communication. The apparatus may include means for obtaining configuration information associated with an inactivity timer for RFID communications, the configuration information indicating that the inactivity timer is to be stopped in accordance with an RFID operation being initiated and that the inactivity timer is to be restarted in accordance with the RFID operation being completed. The apparatus may include means for starting the inactivity timer based at least in part on executing an RFID application associated with performing the RFID communications. The apparatus may include means for disabling the RFID communications by the apparatus based at least in part on an expiration of the inactivity timer.

Aspects generally include a method, apparatus, system, computer program product, non-transitory computer-readable medium, user device, user equipment, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram of an example environment in which systems and/or methods described herein may be implemented.

FIG. 2 is a diagram illustrating example components of a device, in accordance with the present disclosure.

FIG. 3 is a diagram illustrating an example of timer-based radio frequency identification operation management, in accordance with the present disclosure.

FIG. 4 is a diagram illustrating an example of timer-based radio frequency identification operation management using a single inactivity timer, in accordance with the present disclosure.

FIG. 5 is a diagram illustrating an example of timer-based radio frequency identification operation management using multiple inactivity timers, in accordance with the present disclosure.

FIG. 6 is a flowchart of an example process associated with timer-based radio frequency identification operation management, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Radio frequency identification (RFID) is a technology that uses electromagnetic fields to wirelessly transmit data between an RFID device and an RFID reader. An RFID device, such as an RFID tag, may include a microchip for storing data and an antenna for communicating with the RFID reader. RFID devices can be passive, relying on signals transmitted by the reader for power, or can be active, such as by being equipped with batteries for greater range and functionality. A user equipment (UE) serving as an RFID reader may generate radio frequency signals to nearby RFID devices, thereby enabling the RFID devices to transmit stored data back to the UE. In some examples, a user of the UE may activate an RFID application for performing RFID operations. The RFID application may send a signal to a modem of the UE to enable RFID communications by the UE. However, the user may fail to close the RFID application even after the RFID operations are complete. This may result in RFID communications being enabled at the UE for a duration even though the UE is no longer performing any RFID operations. When RFID is enabled, wireless wide area network (WWAN) communications may be disabled or constrained to prioritize the RFID communications. Therefore, the UE may not be able to perform WWAN communications while the RFID application is active. In some cases, this may result in unnecessary power consumption at the UE. For example, the RFID application may continue to consume energy resources of the UE even though the UE is not currently performing any RFID operations. Additionally, this may result in denial of service due to the WWAN communications being suspended. For example, this may result in the UE failing to receive emergency warnings, such as earthquake and tsunami warning system (ETWS) signals, public warning service (PWS) signals, and commercial mobile alert system (CMAS) signals, among other examples. Further, this may result in a reduction of WWAN capabilities at the UE, such as an inability of the UE to perform WWAN communications while the RFID application is active.

Some implementations described herein enable timer-based RFID operation management. In some implementations, a UE may obtain configuration information associated with an inactivity timer for RFID communications. The configuration information may indicate that the inactivity timer is to be stopped in accordance with an RFID operation being initiated and that the inactivity timer is to be restarted in accordance with the RFID operation being completed. The UE may start the inactivity timer based at least in part on executing an RFID application. The UE may stop the inactivity timer based at least in part on an RFID operation being initiated by the UE and may restart the inactivity timer after a completion of the RFID operation. Subsequently, the UE may disable the RFID communications based at least in part on an expiration of the inactivity timer. For example, if no RFID operations are performed for a duration that is in accordance with the inactivity timer, the UE may close the RFID application or may otherwise suspend or disable RFID communications by the UE. In some implementations, the UE may manage multiple inactivity timers. For example, the UE may use a maximum duration timer if the UE is located less than a threshold distance away from a target location or may use a location-based timer if the UE is located greater than a threshold distance away from the target location. Additionally, or alternatively, the UE may use the maximum duration timer if the UE is located within a target cell or may use a cell-based timer if the UE is located outside of the target cell. Additionally, or alternatively, the UE may use a stationary timer if the UE is in a stationary state or may use a movement timer if the UE is in a moving state.

Operating the one or more inactivity timers may enable the UE to suspend or disable RFID communications by the UE when RFID operations have not been performed for a duration of the inactivity timers. As a result, energy consumption by the UE may be reduced. For example, closing an RFID application may prevent the RFID application from consuming energy resources of the UE when RFID operations are no longer being performed. Additionally, communications by the UE over WWAN networks may be improved when RFID operations are not being performed by the UE. Further, denial of service resulting from suspensions of WWAN communications by the UE may be reduced or eliminated. For example, enabling the WWAN communications may enable the UE to receive emergency warning signals when RFID operations are not currently being performed by the UE. These example advantages, among others, are described in more detail below.

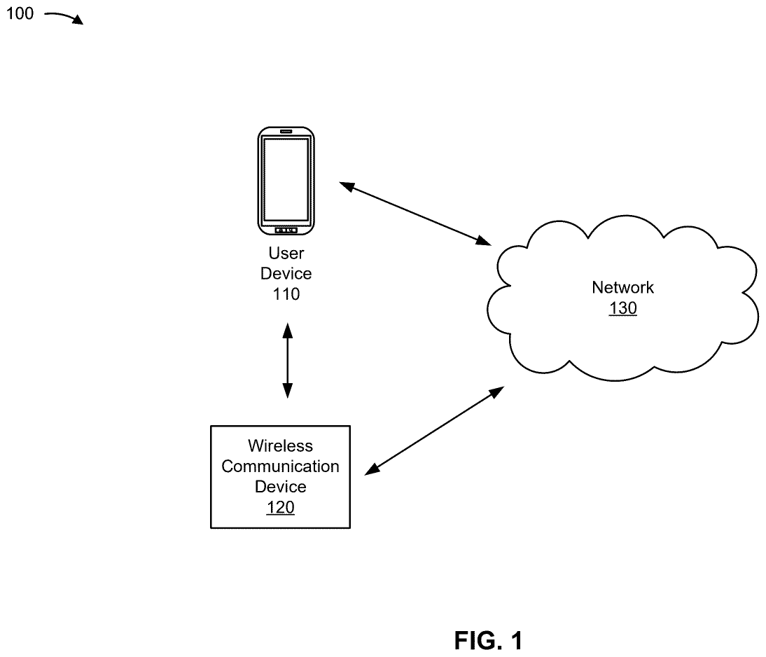

FIG. 1 is a diagram of an example environment 100 in which systems and/or methods described herein may be implemented. As shown in FIG. 1, environment 100 may include a user device 110, a wireless communication device 120, and a network 130. Devices of environment 100 may interconnect via wired connections, wireless connections, or a combination of wired and wireless connections.

The user device 110 may include one or more devices capable of receiving, generating, storing, processing, and/or providing information associated with timer-based RFID operation management, as described elsewhere herein. The user device 110 may include a communication device and/or a computing device. For example, the user device 110 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The wireless communication device 120 includes one or more devices capable of receiving, generating, storing, processing, and/or providing information associated with timer-based RFID operation management. For example, the wireless communication device 120 may include a base station, an access point, and/or the like. Additionally, or alternatively, wireless communication device 120 may include a communication and/or computing device, such as a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The network 130 may include one or more wired and/or wireless networks. For example, the network 130 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 130 enables communication among the devices of environment 100.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

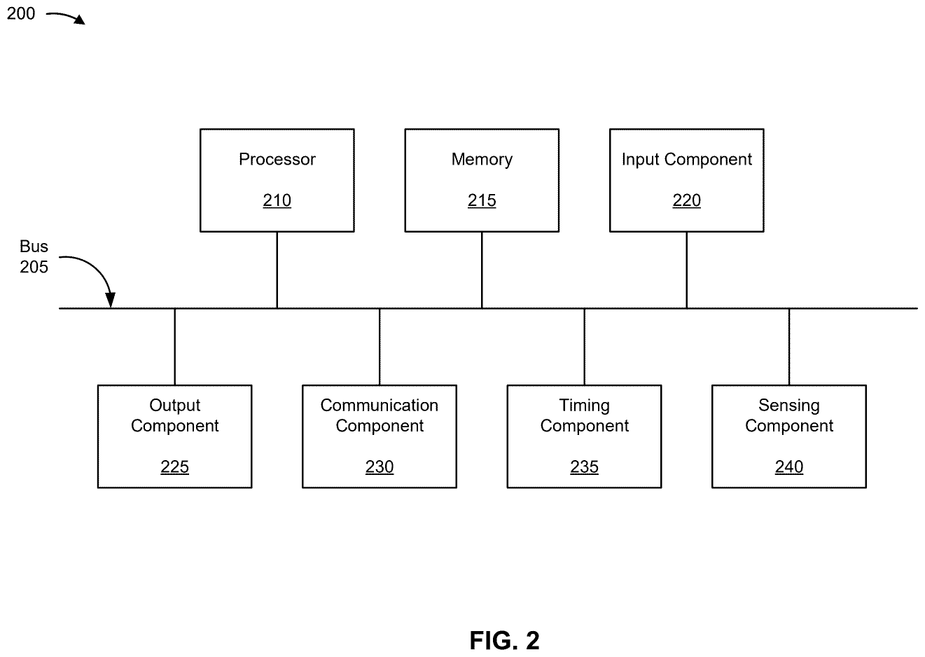

FIG. 2 is a diagram illustrating example components of a device 200, in accordance with the present disclosure. The device 200 may correspond to the user device 110 and/or the wireless communication device 120. In some implementations, the user device 110 and/or the wireless communication device 120 may include one or more devices 200 and/or one or more components of the device 200. As shown in FIG. 2, the device 200 may include a bus 205, a processor 210, a memory 215, an input component 220, an output component 225, a communication component 230, a timing component 235 and/or a sensing component 240.

The bus 205 may include one or more components that enable wired and/or wireless communication among the components of the device 200. The bus 205 may couple together two or more components of FIG. 2, such as via operative coupling, communicative coupling, electronic coupling, and/or electric coupling. For example, the bus 205 may include an electrical connection (e.g., a wire, a trace, and/or a lead) and/or a wireless bus. The processor 210 may include a central processing unit, a graphics processing unit, a microprocessor, a controller, a microcontroller, a digital signal processor, a field-programmable gate array, an application-specific integrated circuit, and/or another type of processing component. The processor 210 may be implemented in hardware, firmware, or a combination of hardware and software. In some implementations, the processor 210 may include one or more processors capable of being programmed to perform one or more operations or processes described elsewhere herein.

The memory 215 may include volatile and/or nonvolatile memory. For example, the memory 215 may include random access memory (RAM), read only memory (ROM), a hard disk drive, and/or another type of memory (e.g., a flash memory, a magnetic memory, and/or an optical memory). The memory 215 may include internal memory (e.g., RAM, ROM, or a hard disk drive) and/or removable memory (e.g., removable via a universal serial bus connection). The memory 215 may be a non-transitory computer-readable medium. The memory 215 may store information, one or more instructions, and/or software (e.g., one or more software applications) related to the operation of the device 200. In some implementations, the memory 215 may include one or more memories that are coupled (e.g., communicatively coupled) to one or more processors (e.g., processor 210), such as via the bus 205. Communicative coupling between a processor 210 and a memory 215 may enable the processor 210 to read and/or process information stored in the memory 215 and/or to store information in the memory 215.

The input component 220 may enable the device 200 to receive input, such as user input and/or sensed input. For example, the input component 220 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 225 may enable the device 200 to provide output, such as via a display, a speaker, and/or a light-emitting diode. The communication component 230 may enable the device 200 to communicate with other devices via a wired connection and/or a wireless connection. For example, the communication component 230 may include a receiver, a transmitter, a transceiver, a modem, a network interface card, and/or an antenna.

The timing component 235 may manage one or more inactivity timers for RFID communications. The timing component 235 may be configured to stop an inactivity timer in accordance with an RFID operation being initiated by the device 200 and may be configured to restart the inactivity timer in accordance with the RFID operation being completed by the device 200. In some implementations, the timing component 235 may start the inactivity timer based at least in part on the device 200 executing an RFID application. The timing component 235 may detect that the device 200 is performing an RFID operation, may stop the inactivity timer in accordance with detecting that the device 200 is performing the RFID operation, and may restart the inactivity timer in accordance with a completion of the RFID operation. Subsequently, the timing component 235 may indicate an expiration of the inactivity timer and may cause RFID communications by the device 200 to be suspended or disabled. In some implementations, the timing component 235 may manage multiple inactivity timers for RFID communications. For example, the timing component 235 may manage a maximum duration timer, a location-based timer, a cell-based timer, a stationary timer, and/or a movement timer, among other examples.

The sensing component 240 may sense one or more conditions of the device 200. In some implementations, the sensing component 240 may determine whether a movement by the device 200 is greater than or equal to a displacement threshold. Additionally, or alternatively, the sensing component 240 may determine whether the device 200 has moved from a target cell to one or more other cells. In some other implementations, the sensing component 240 may determine whether the device 200 is in a stationary condition or is in a moving condition. The sensing component 240 may communicate with the timing component 235 to enable or disable RFID communications by the device 200 in accordance with the one or more conditions. Additional details regarding these features are described below.

The device 200 may perform one or more operations or processes described herein. For example, a non-transitory computer-readable medium (e.g., memory 215) may store a set of instructions (e.g., one or more instructions or code) for execution by the processor 210. The processor 210 may execute the set of instructions to perform one or more operations or processes described herein. In some implementations, execution of the set of instructions, by one or more processors 210, causes the one or more processors 210 and/or the device 200 to perform one or more operations or processes described herein. In some implementations, hardwired circuitry may be used instead of or in combination with the instructions to perform one or more operations or processes described herein. Additionally, or alternatively, the processor 210 may be configured to perform one or more operations or processes described herein. Thus, aspects described herein are not limited to any specific combination of hardware circuitry and software.

In some aspects, the device 200 may include means for obtaining configuration information associated with an inactivity timer for RFID communications, the configuration information indicating that the inactivity timer is to be stopped in accordance with an RFID operation being initiated and that the inactivity timer is to be restarted in accordance with the RFID operation being completed; means for starting the inactivity timer based at least in part on executing an RFID application associated with performing the RFID communications; and/or means for disabling the RFID communications by the UE based at least in part on an expiration of the inactivity timer. In some aspects, the means for device 200 to perform processes and/or operations described herein may include one or more components of device 200 described in connection with FIG. 2, such as bus 205, processor 210, memory 215, input component 220, output component 225, communication component 230, the timing component 235 and/or the sensing component 240.

The number and arrangement of components shown in FIG. 2 are provided as an example. The device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

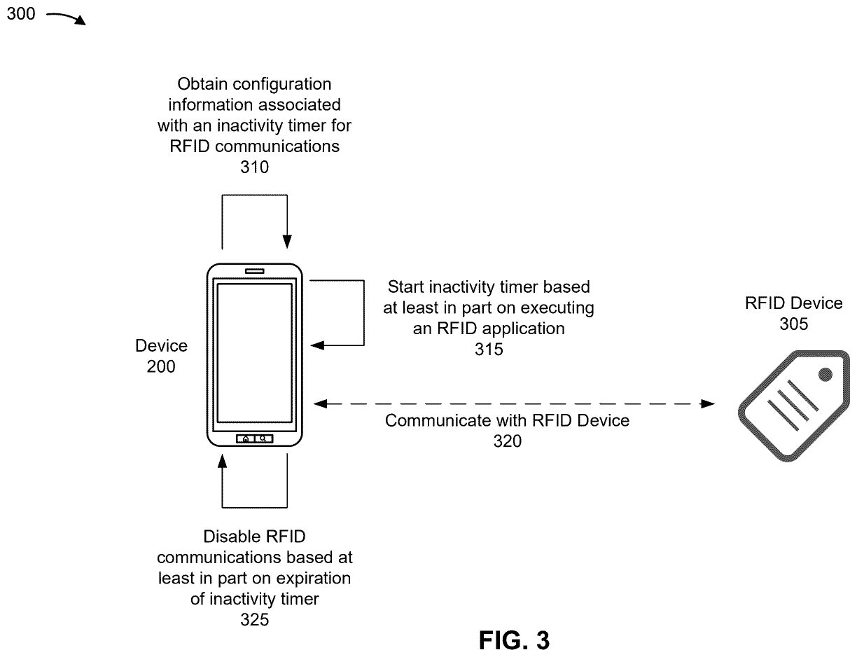

FIG. 3 is a diagram illustrating an example 300 of timer-based radio frequency identification operation management, in accordance with the present disclosure. The device 200 may communicate with an RFID device 305. In some implementations, the device 200 is a UE and the RFID device 305 is an RFID tag.

As shown by reference number 310, the device 200 may obtain configuration information associated with an inactivity timer. The configuration information may indicate that the inactivity timer is to be stopped in accordance with an RFID operation being initiated and that the inactivity timer is to be restarted in accordance with the RFID operation being completed. In some implementations, the configuration information may be stored in a memory of the device 200. In some other implementations, the configuration information may be signaled to the device 200 by another device, such as a network node associated with the network 130. In some implementations, the configuration information may indicate a duration of the inactivity timer. In some other implementations, the duration of the inactivity timer may be stored in the memory of the device 200.

As shown by reference number 315, the device 200 may start the inactivity timer based at least in part on executing an RFID application. The RFID application may be any application executing on the device 200 that can be used to perform or manage RFID operations. In some implementations, a user of the device 200 may execute (e.g., launch) the RFID application on the device 200, thereby enabling the device 200 to perform one or more RFID operations using the RFID application. The RFID application, based at least in part on being executed on the device 200, may indicate to a modem of the device 200 that the device 200 is to begin performing RFID communications.

In one example, the duration of the inactivity timer may be ten seconds. Therefore, if the device 200 does not perform any RFID operations for a period of ten seconds, the RFID application may be closed and RFID communications by the device 200 may be suspended or disabled. In some implementations, the user of the device 200 may execute the RFID application on the device 200 but may not perform any RFID operations using the RFID application. In this example, the RFID application may be closed and RFID communications by the device 200 may be suspended or disabled after the duration of the inactivity timer, such as ten seconds after the application is launched on the device 200.

As shown by reference number 320, the device 200 may communicate with the RFID device 305. In some implementations, communicating with the RFID device 305 may include reading data from the RFID device 305. For example, the RFID device 305 may be an RFID tag, and the application of the device 200 may use one or more communication components of the device 200, such as the communication component 225, to read the data from the RFID tag.

As shown by reference number 325, the device 200 may disable RFID communications based at least in part on an expiration of the inactivity timer. For example, if no RFID operations are performed by the device 200 within a duration of the inactivity timer (for example, ten seconds), the device 200 may close the RFID application and may suspend or disable RFID communications.

In some implementations, the inactivity timer may expire in accordance with a most recent RFID operation performed by the device 200. For example, an RFID application may be executed on the device 200 and the inactivity timer may be started based at least in part on the RFID application being executed. A period of time after launching the RFID application, such as four seconds after launching the RFID application, the device 200 may perform an RFID operation, such as reading data from the RFID device 305. Therefore, the device 200 may stop the inactivity timer. After the RFID operation is complete, such as when the device 200 has read the data from the RFID device 305, the device 200 may restart the inactivity timer. Restarting the inactivity timer may include starting the inactivity timer to the original duration. For example, the inactivity timer may be reset to the original duration of ten seconds. If, after another ten seconds, the device 200 does not perform any additional RFID operations, the device 200 may close the RFID application and may disable or suspend RFID communications. Alternatively, if the device 200 does perform another RFID operation within a duration of the inactivity timer (e.g., within ten seconds of resetting the inactivity timer), the device 200 may stop the inactivity timer and may restart the inactivity timer, as described above. This process may repeat until an expiration of the inactivity timer. Therefore, the device 200 may continue to perform RFID operations until a duration of ten seconds without any RFID operations is satisfied. After the duration is satisfied, the RFID application may be closed and RFID communications by the device 200 may be suspended or disabled. In this case, other wireless communications, such as WWAN communications, may be enabled and/or prioritized over RFID communications.

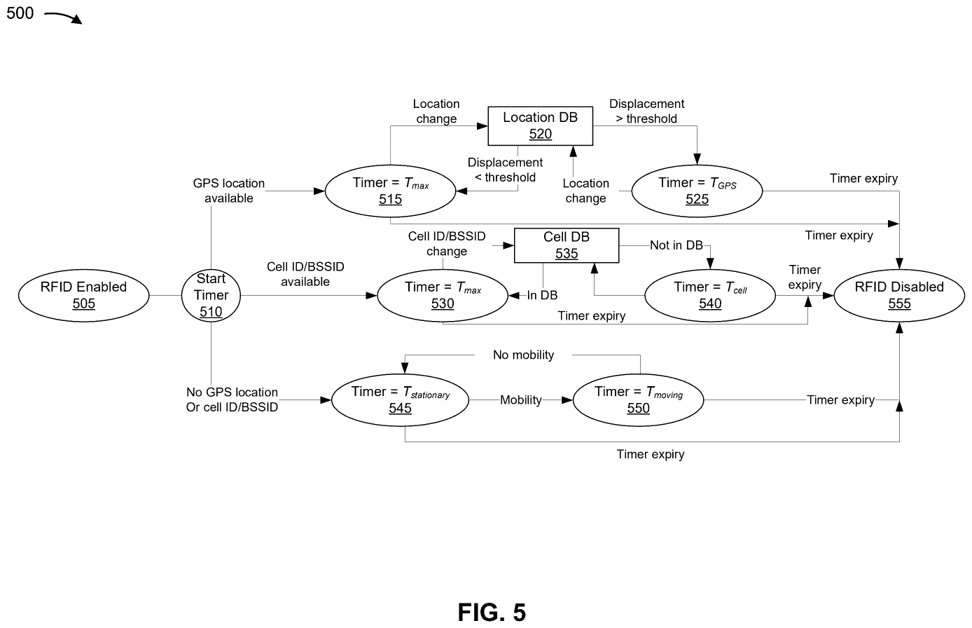

In some implementations, the device 200 may be configured with multiple inactivity timers. For example, the device 200 may operate a maximum duration timer if the device 200 is located less than a threshold distance away from a target location or may operate a location-based timer if the device 200 is located greater than a threshold distance away from the target location. Additionally, or alternatively, the device 200 may operate the maximum duration timer if the device 200 is located within a target cell or may operate a cell-based timer if the device 200 is located outside of the target cell. Additionally, or alternatively, the device 200 may operate a stationary timer if the device 200 is in a stationary state or may operate a movement timer if the device 200 is in a moving state. In some implementations, a duration of the location-based timer and a duration of the cell-based timer are less than the duration of the maximum duration timer. Additionally, or alternatively, a duration of the movement timer may be less than a duration of the stationary timer. Additional details regarding these features are described in connection with FIG. 5.

As indicated above, FIG. 3 is provided as an example. Other examples may differ from what is described with regard to FIG. 3.

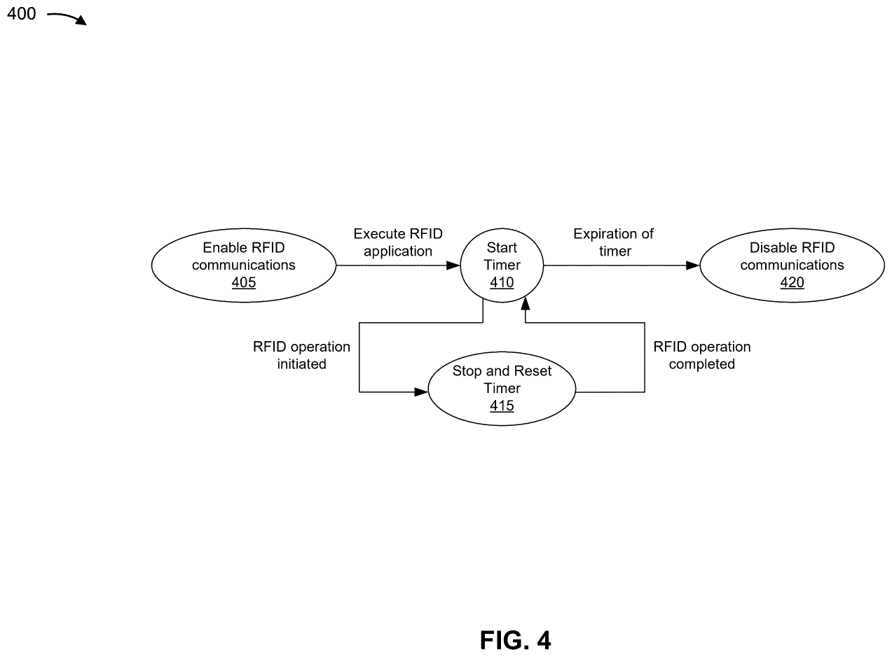

FIG. 4 is a diagram illustrating an example 400 of timer-based radio frequency identification operation management using a single inactivity timer, in accordance with the present disclosure.

As shown by reference number 405, RFID communications may be enabled at the device 200. For example, a modem of the device 200 may be configured to read data from an RFID device, such as the RFID device 305 described in connection with FIG. 3. In some examples, the device 200 is a UE and the RFID device 305 is an RFID tag.

As shown by reference number 410, a timer may be started. The timer may be an inactivity timer (T_{inactivity}). The timer may be started in accordance with an RFID application being executed on the device 200. For example, once the RFID application is launched on the device 200, the inactivity timer may begin running. In one example, the timer may have a duration of thirty seconds.

As shown by reference number 415, the timer may be stopped and reset. For example, the device 200 may stop the inactivity timer (T_{inactivity}) in accordance with an RFID operation being initiated by the RFID application. In some implementations, the RFID operation may include reading data from the RFID device 305. Once the RFID operation is complete, such as when all of the data, or a subset of the data, has been read from the RFID device 305, the inactivity timer (T_{inactivity}) may be reset. In some implementations, resetting the timer may include restarting the timer to the original duration (for example, thirty seconds).

As shown by reference number 420, RFID communications may be disabled. The RFID communications by the device 200 may be disabled in accordance with an expiration of the inactivity timer (T_{inactivity}). For example, if thirty seconds pass without the device 200 (e.g., the RFID application) performing any RFID operations, RFID communications may be suspended on the device 200. In some implementations, the device 200, upon disabling the RFID communications, may enable (and/or prioritize) other wireless communications, such as WWAN communications, by the device 200.

As indicated above, FIG. 4 is provided as an example. Other examples may differ from what is described with regard to FIG. 4.

FIG. 5 is a diagram illustrating an example 500 of timer-based radio frequency identification operation management using multiple inactivity timers, in accordance with the present disclosure.

As shown by reference number 505, RFID communications may be enabled at the device 200. For example, a modem of the device 200 may be configured to read data from an RFID device, such as the RFID device 305 described in connection with FIG. 3. In some examples, the device 200 is a UE and the RFID device 305 is an RFID tag.

As shown by reference number 510, one or more timers may be started. The one or more timers may be started in accordance with an RFID application being executed on the device 200. For example, once the RFID application is launched on the device 200, one or more inactivity timers may be initiated. In some implementations, the device 200 may be configured with multiple inactivity timers. For example, the device 200 may be configured with a maximum duration timer, a location-based timer, a cell-based timer, a stationary timer, and/or a movement timer, among other examples. Additional details regarding these timers are described below. In some implementations, multiple inactivity timers may be running at the same time. For example, the device 200 may simultaneously operate the location-based timer and the maximum duration timer in accordance with the device 200 being at a distance that is greater than threshold distance from a target location and in accordance with the device 200 being located within a target cell.

As shown by reference number 515, the maximum duration timer (Tₘₐₓ) may be started. The maximum duration timer may be started in accordance with location information, such as global positioning system (GPS) location information, being available for the device 200. When GPS location information is available, one or more locations where RFID is enabled and/or where RFID operations can be performed by the device 200 may be stored (e.g., fingerprinted) in a memory of the device 200. The GPS locations may be expanded to a proximity from the GPS coordinates and may be saved to a location database (location DB). If the current location of the device 200 reaches a certain threshold distance from the closest area in the location database, a shorter inactivity timer, such as the location-based timer, may be started.

As shown by reference number 520, the device 200 may access the location database. The device 200 may access the location database based at least in part on a movement of the device 200. For example, the device 200 may access the location database in accordance with detecting a movement of the device 200 from one GPS location to another GPS location. Additionally, or alternatively, the device 200 may access the location database periodically, such as in accordance with an interval. The device 200 may compare the current location of the device 200 to a displacement threshold. If the current displacement of the device 200 is less than (or less than or equal to) the displacement threshold, the device 200 may continue to use the maximum duration timer (Tₘₐₓ).

As shown by reference number 525, if the current displacement of the device 200 is greater than (or greater than or equal to) the displacement threshold, the device 200 may switch to the location-based timer (T_{GPS}). The location-based timer may have a duration that is shorter than the duration of the maximum duration timer. For example, the maximum duration timer may have a duration of thirty seconds while the location-based timer may have a duration of fifteen seconds. Therefore, the device 200 may use a shorter inactivity timer if the device is located more than a threshold distance away from a target location (such as any of the GPS coordinates and the corresponding proximities included in the location database).

As shown by reference number 530, the maximum duration timer (Tₘₐₓ) may be started in accordance with cell identifier (cell ID) information or basic service cell identifier (BSSID) information being available for the device 200. When the cell ID information (e.g., WWAN service information) or the BSSID information (e.g., WLAN service information) is available, the corresponding cell IDs or BSSIDs associated with the device 200 may be stored (e.g., fingerprinted) in a memory of the device 200, such as in a cell database (cell DB) of the device 200. If the device 200 moves from a cell or basic service cell having an identifier that is stored in the cell database to another cell or basic service cell having an identifier that is not stored in the cell database, a shorter inactivity timer, such as the cell-based timer, may be started.

As shown by reference number 535, the device 200 may access the cell database. The device 200 may access the cell database based at least in part on a movement of the device 200. For example, the device 200 may access the cell database in accordance with detecting a movement of the device 200 from one cell or basic service cell to another cell or basic service cell. Additionally, or alternatively, the device 200 may access the location database periodically, such as in accordance with an interval. The device 200 may compare an identifier of a current cell in which the device 200 is located to the identifiers stored in the cell database. If the current location of the device 200 is within a cell having an identifier that is stored in the cell database, the device 200 may continue to use the maximum duration timer (Tₘₐₓ).

As shown by reference number 540, if the current location of the device 200 is not within a cell having an identifier that is stored in the cell database, the device 200 may switch to the cell-based timer (T_{cell}). For example, if the device 200 determines that a current cell of the device 200 has an identifier that is not stored in the cell database, the device 200 may switch to the cell-based timer. The cell-based timer may have a duration that is shorter than the duration of the maximum duration timer. For example, the maximum duration timer may have a duration of thirty seconds while the cell-based timer may have a duration of twenty seconds. Therefore, the device 200 may use a shorter inactivity timer if the device is located outside of a cell or basic service cell associated with the device 200 and having an identifier that is stored in the cell database.

As shown by reference number 545, a stationery timer (T_{stationary}) may be started. The stationary timer may be started in accordance with location information (such as GPS location information) and cell information (such as cell ID or BSSID information) not being available for the device 200. Additionally, or alternatively, the stationary timer may be started in accordance with the device 200 being in a stationary state. For example, the device 200 may determine that the device 200 is not moving and may initiate the stationary timer. In some implementations, the stationary timer may be the default timer when location information and cell information is not available. For example, if the location information and the cell information is not available, the device 200 may start the stationary timer unless the device 200 is in a moving state.

As shown by reference number 550, a moving timer (T_{moving}) may be started based at least in part on the device 200 being in a moving state. For example, if the device 200 detects that the device 200 has switched from being stationary to moving, the device 200 may start the moving timer. The moving timer may have a duration that is shorter than a duration of the stationary timer. For example, the stationary timer may have a duration of twenty-two seconds and the moving timer may have a duration of twelve seconds. In some implementations, the device 200 may determine whether the device 200 is in a moving state using a step counter or using other sensors associated with the device 200.

As described herein, two or more timers may be running at the same time for the device 200. In some implementations, the device 200 may switch between timers based on one or more conditions of the device 200. For example, if the shorter movement-based timer is running and the device 200 moves back to a location within the displacement threshold, the device 200 may switch back to the longer maximum duration timer. In another example, if the shorter cell-based timer is running and the device 200 moves back to a cell having an identifier that is stored in the cell database, the device 200 may switch back to the longer maximum duration timer. In yet another example, if the shorter moving timer is running and the device 200 is stationary for a certain timer period (which may be configured at the device 200), the device 200 may switch back to the longer stationary timer.

As shown by reference number 555, RFID communications may be disabled. The RFID communications by the device 200 may be disabled in accordance with an expiration of any timer of the multiple timers. For example, the RFID communications by the device 200 may be disabled based at least in part on an expiration of the maximum duration timer, the location-based timer, the cell-based timer, the stationary timer, or the moving timer. In the example where multiple timers are running at the same time, the RFID communications may be disabled based at least in part on an expiration of one of the timers. For example, if the maximum duration timer and the cell-based timer are running at the same time and the cell-based timer expires, the RFID communications may be disabled even if the maximum duration timer is still running.

As indicated above, FIG. 5 is provided as an example. Other examples may differ from what is described with regard to FIG. 5.

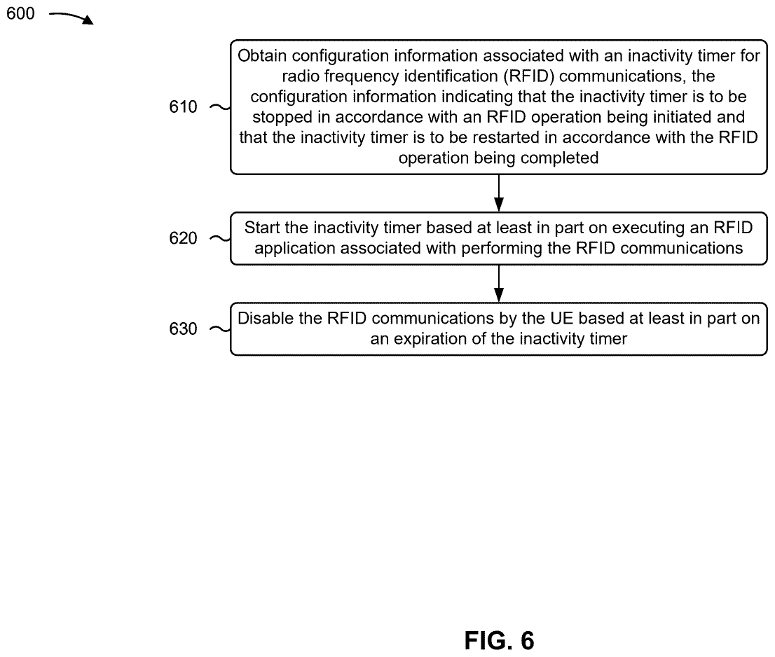

FIG. 6 is a flowchart of an example process 600 associated with timer-based radio frequency identification operation management, in accordance with the present disclosure. In some aspects, one or more process blocks of FIG. 6 are performed by a device (e.g., device 200). In some aspects, the device is a UE. In some aspects, one or more process blocks of FIG. 6 are performed by another device or a group of devices separate from or including the device, such as the user device 110 and/or the wireless communication device 120). Additionally, or alternatively, one or more process blocks of FIG. 6 may be performed by one or more components of device 200, such as processor 210, memory 215, input component 220, output component 225, communication component 230, timing component 235 and/or sensing component 240.

As shown in FIG. 6, process 600 may include obtaining configuration information associated with an inactivity timer for RFID communications, the configuration information indicating that the inactivity timer is to be stopped in accordance with an RFID operation being initiated and that the inactivity timer is to be restarted in accordance with the RFID operation being completed (block 610). For example, the device may obtain configuration information associated with an inactivity timer for RFID communications, the configuration information indicating that the inactivity timer is to be stopped in accordance with an RFID operation being initiated and that the inactivity timer is to be restarted in accordance with the RFID operation being completed, as described above.

As further shown in FIG. 6, process 600 may include starting the inactivity timer based at least in part on executing an RFID application associated with performing the RFID communications (block 620). For example, the device may start the inactivity timer based at least in part on executing an RFID application associated with performing the RFID communications, as described above.

As further shown in FIG. 6, process 600 may include disabling the RFID communications based at least in part on an expiration of the inactivity timer (block 630). For example, the device may disable the RFID communications by the device based at least in part on an expiration of the inactivity timer, as described above.

Process 600 may include additional aspects, such as any single aspect or any combination of aspects described below and/or in connection with one or more other processes described elsewhere herein.

In a first aspect, process 600 includes stopping the inactivity timer, after starting the inactivity timer and prior to the expiration of the inactivity timer, based at least in part on the RFID operation being initiated, and restarting the inactivity timer, after stopping the inactivity timer, based at least in part on the RFID operation being completed.

In a second aspect, alone or in combination with the first aspect, process 600 includes disabling WWAN communications by the device based at least in part on the RFID operation being initiated, and enabling the WWAN communications by the device based at least in part on the expiration of the inactivity timer and based at least in part on disabling the RFID communications by the device.

In a third aspect, alone or in combination with one or more of the first and second aspects, disabling the RFID communications by the device comprises providing, to a modem of the device, an indication to stop performing RFID communications while the inactivity timer is active.

In a fourth aspect, alone or in combination with one or more of the first through third aspects, the configuration information is associated with a plurality of inactivity timers, the plurality of inactivity timers including two or more of a maximum duration timer, a location-based timer, a cell-based timer, a stationary timer, or a movement timer.

In a fifth aspect, alone or in combination with one or more of the first through fourth aspects, two or more inactivity timers of the plurality of inactivity timers are active at the same time, and disabling the RFID communications by the device based at least in part on an expiration of the inactivity timer comprises disabling the RFID communications by the device based at least in part on an expiration of a single inactivity timer of the two or more inactivity timers.

In a sixth aspect, alone or in combination with one or more of the first through fifth aspects, process 600 includes identifying a target location of the device, and performing at least one of initiating the maximum duration timer based at least in part on a current location of the device being within a threshold distance of the target location of the device, or initiating the location-based timer based at least in part on the current location of the device being outside of the threshold distance of the target location of the device, wherein a duration of the maximum duration timer is greater than a duration of the location-based timer.

In a seventh aspect, alone or in combination with one or more of the first through sixth aspects, process 600 includes storing a plurality of GPS coordinates corresponding to one or more locations where RFID communications are enabled or one or more locations where RFID operations have been performed by the device, wherein the target location of the device corresponds to at least one GPS coordinate of the plurality of GPS coordinates or corresponds to an area that is based at least in part on the plurality of GPS coordinates.

In an eighth aspect, alone or in combination with one or more of the first through seventh aspects, process 600 includes detecting, after initiating the location-based timer, that the device has moved within the threshold distance of the target location of the device, deactivating the location-based timer, and starting the maximum duration timer.

In a ninth aspect, alone or in combination with one or more of the first through eighth aspects, process 600 includes detecting, after initiating the maximum duration timer, that the device has moved outside of the threshold distance of the target location of the device, and starting the location-based timer.

In a tenth aspect, alone or in combination with one or more of the first through ninth aspects, process 600 includes identifying one or more cell identifiers or one or more basic service set identifiers corresponding to one or more cells associated with the device, and performing at least one of initiating the maximum duration timer based at least in part on the device being located within the one or more cells, or initiating the cell-based timer based at least in part on the device not being located within the one or more cells, wherein a duration of the maximum duration timer is greater than a duration of the cell-based timer.

In an eleventh aspect, alone or in combination with one or more of the first through tenth aspects, process 600 includes storing the one or more cell identifiers or the one or more basic service set identifiers corresponding to the one or more cells associated with the device, wherein each cell of the one or more cells associated with the device corresponds to a cell in which RFID communications are enabled or a cell in which RFID operations have been performed by the device.

In a twelfth aspect, alone or in combination with one or more of the first through eleventh aspects, process 600 includes detecting, after initiating the cell-based timer, that the device has moved to a location that is within the one or more cells, deactivating the cell-based timer, and starting the maximum duration timer.

In a thirteenth aspect, alone or in combination with one or more of the first through twelfth aspects, process 600 includes detecting, after initiating the maximum duration timer, that the device has moved to a location that is outside of the one or more cells, and starting the cell-based timer.

In a fourteenth aspect, alone or in combination with one or more of the first through thirteenth aspects, process 600 includes identifying whether the device is stationary, and performing at least one of initiating the stationary timer based at least in part on the device being stationary, or initiating the movement timer based at least in part on the device not being stationary, wherein a duration of the stationary timer is greater than a duration of the movement timer.

In a fifteenth aspect, alone or in combination with one or more of the first through fourteenth aspects, the stationary timer or the movement timer is initiated based at least in part on global positioning information or cell-based information not being available to the device.

In a sixteenth aspect, alone or in combination with one or more of the first through fifteenth aspects, identifying whether the device is stationary comprises using a step counter or one or more sensors associated with the device.

In a seventeenth aspect, alone or in combination with one or more of the first through sixteenth aspects, the inactivity timer has a first duration in accordance with the device being configured to perform wireless local area network communications and wireless wide area network communications or has a second duration in accordance with the device being configured to perform wireless local area network communications and not being configured to perform wireless wide area network communications, the second duration being longer than the first duration.

Although FIG. 6 shows example blocks of process 600, in some aspects, process 600 includes additional blocks, fewer blocks, different blocks, or differently arranged blocks than those depicted in FIG. 6. Additionally, or alternatively, two or more of the blocks of process 600 may be performed in parallel.

The following provides an overview of some Aspects of the present disclosure:
Aspect 1: A method of wireless communication performed by a user equipment (UE), comprising: obtaining configuration information associated with an inactivity timer for radio frequency identification (RFID) communications, the configuration information indicating that the inactivity timer is to be stopped in accordance with an RFID operation being initiated and that the inactivity timer is to be restarted in accordance with the RFID operation being completed; starting the inactivity timer based at least in part on executing an RFID application associated with performing the RFID communications; and disabling the RFID communications by the UE based at least in part on an expiration of the inactivity timer.
Aspect 2: The method of Aspect 1, further comprising: stopping the inactivity timer, after starting the inactivity timer and prior to the expiration of the inactivity timer, based at least in part on the RFID operation being initiated; and restarting the inactivity timer, after stopping the inactivity timer, based at least in part on the RFID operation being completed.
Aspect 3: The method of any of Aspects 1-2, further comprising: disabling wireless wide area network (WWAN) communications by the UE based at least in part on the RFID operation being initiated; and enabling the WWAN communications by the UE based at least in part on the expiration of the inactivity timer and based at least in part on disabling the RFID communications by the UE.
Aspect 4: The method of any of Aspects 1-3, wherein disabling the RFID communications by the UE comprises providing, to a modem of the UE, an indication to stop performing RFID communications while the inactivity timer is active.
Aspect 5: The method of any of Aspects 1-4, wherein the configuration information is associated with a plurality of inactivity timers, the plurality of inactivity timers including two or more of a maximum duration timer, a location-based timer, a cell-based timer, a stationary timer, or a movement timer.
Aspect 6: The method of Aspect 5, wherein two or more inactivity timers of the plurality of inactivity timers are active at the same time, and wherein disabling the RFID communications by the UE based at least in part on an expiration of the inactivity timer comprises disabling the RFID communications by the UE based at least in part on an expiration of a single inactivity timer of the two or more inactivity timers.
Aspect 7: The method of Aspect 5, further comprising: identifying a target location of the UE; and performing at least one of: initiating the maximum duration timer based at least in part on a current location of the UE being within a threshold distance of the target location of the UE; or initiating the location-based timer based at least in part on the current location of the UE being outside of the threshold distance of the target location of the UE, wherein a duration of the maximum duration timer is greater than a duration of the location-based timer.
Aspect 8: The method of Aspect 7, further comprising storing a plurality of global positioning system (GPS) coordinates corresponding to one or more locations where RFID communications are enabled or one or more locations where RFID operations have been performed by the UE, wherein the target location of the UE corresponds to at least one GPS coordinate of the plurality of GPS coordinates or corresponds to an area that is based at least in part on the plurality of GPS coordinates.
Aspect 9: The method of Aspect 7, further comprising: detecting, after initiating the location-based timer, that the UE has moved within the threshold distance of the target location of the UE; deactivating the location-based timer; and starting the maximum duration timer.
Aspect 10: The method of Aspect 7, further comprising: detecting, after initiating the maximum duration timer, that the UE has moved outside of the threshold distance of the target location of the UE; and starting the location-based timer.
Aspect 11: The method of Aspect 5, further comprising: identifying one or more cell identifiers or one or more basic service set identifiers corresponding to one or more cells associated with the UE; and performing at least one of: initiating the maximum duration timer based at least in part on the UE being located within the one or more cells; or initiating the cell-based timer based at least in part on the UE not being located within the one or more cells, wherein a duration of the maximum duration timer is greater than a duration of the cell-based timer.
Aspect 12: The method of Aspect 11, further comprising storing the one or more cell identifiers or the one or more basic service set identifiers corresponding to the one or more cells associated with the UE, wherein each cell of the one or more cells associated with the UE corresponds to a cell in which RFID communications are enabled or a cell in which RFID operations have been performed by the UE.
Aspect 13: The method of Aspect 11, further comprising: detecting, after initiating the cell-based timer, that the UE has moved to a location that is within the one or more cells; deactivating the cell-based timer; and starting the maximum duration timer.
Aspect 14: The method of Aspect 11, further comprising: detecting, after initiating the maximum duration timer, that the UE has moved to a location that is outside of the one or more cells; and starting the cell-based timer.
Aspect 15: The method of Aspect 5, further comprising: identifying whether the UE is stationary; and performing at least one of: initiating the stationary timer based at least in part on the UE being stationary; or initiating the movement timer based at least in part on the UE not being stationary, wherein a duration of the stationary timer is greater than a duration of the movement timer.
Aspect 16: The method of Aspect 15, wherein the stationary timer or the movement timer is initiated based at least in part on global positioning information or cell-based information not being available to the UE.
Aspect 17: The method of Aspect 15, wherein identifying whether the UE is stationary comprises using a step counter or one or more sensors associated with the UE.
Aspect 18: The method of any of Aspects 1-17, wherein the inactivity timer has a first duration in accordance with the UE being configured to perform wireless local area network communications and wireless wide area network communications or has a second duration in accordance with the UE being configured to perform wireless local area network communications and not being configured to perform wireless wide area network communications, the second duration being longer than the first duration.
Aspect 19: An apparatus for wireless communication at a user equipment (UE), comprising: one or more memories; and one or more processors, coupled to the one or more memories, configured to cause the UE to: obtain configuration information associated with an inactivity timer for radio frequency identification (RFID) communications, the configuration information indicating that the inactivity timer is to be stopped in accordance with an RFID operation being initiated and that the inactivity timer is to be restarted in accordance with the RFID operation being completed; start the inactivity timer based at least in part on executing an RFID application associated with performing the RFID communications; and disable the RFID communications by the UE based at least in part on an expiration of the inactivity timer.
Aspect 20: A non-transitory computer-readable medium storing a set of instructions for wireless communication, the set of instructions comprising: one or more instructions that, when executed by one or more processors of a user equipment (UE), cause the UE to: obtain configuration information associated with an inactivity timer for radio frequency identification (RFID) communications, the configuration information indicating that the inactivity timer is to be stopped in accordance with an RFID operation being initiated and that the inactivity timer is to be restarted in accordance with the RFID operation being completed; start the inactivity timer based at least in part on executing an RFID application associated with performing the RFID communications; and disable the RFID communications by the UE based at least in part on an expiration of the inactivity timer.
Aspect 21: An apparatus for wireless communication, comprising: means for obtaining configuration information associated with an inactivity timer for radio frequency identification (RFID) communications, the configuration information indicating that the inactivity timer is to be stopped in accordance with an RFID operation being initiated and that the inactivity timer is to be restarted in accordance with the RFID operation being completed; means for starting the inactivity timer based at least in part on executing an RFID application associated with performing the RFID communications; and means for disabling the RFID communications by the apparatus based at least in part on an expiration of the inactivity timer.
Aspect 22: A system configured to perform one or more operations recited in one or more of Aspects 1-21.
Aspect 23: An apparatus comprising means for performing one or more operations recited in one or more of Aspects 1-21.
Aspect 24: A non-transitory computer-readable medium storing a set of instructions, the set of instructions comprising one or more instructions that, when executed by a device, cause the device to perform one or more operations recited in one or more of Aspects 1-21.
Aspect 25: A computer program product comprising instructions or code for executing one or more operations recited in one or more of Aspects 1-21.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
one or more memories; and
one or more processors, coupled to the one or more memories, configured to cause the UE to:
obtain configuration information associated with an inactivity timer for radio frequency identification (RFID) communications, the configuration information indicating that the inactivity timer is to be stopped in accordance with an RFID operation being initiated and that the inactivity timer is to be restarted in accordance with the RFID operation being completed;
start the inactivity timer based at least in part on executing an RFID application associated with performing the RFID communications; and
disable the RFID communications by the UE based at least in part on an expiration of the inactivity timer.

2. The apparatus of claim 1, wherein the one or more processors are further configured to cause the UE to:
stop the inactivity timer, after starting the inactivity timer and prior to the expiration of the inactivity timer, based at least in part on the RFID operation being initiated; and
restart the inactivity timer, after stopping the inactivity timer, based at least in part on the RFID operation being completed.

3. The apparatus of claim 1, wherein the one or more processors are further configured to cause the UE to:
disable wireless wide area network (WWAN) communications by the UE based at least in part on the RFID operation being initiated; and
enable the WWAN communications by the UE based at least in part on the expiration of the inactivity timer and based at least in part on disabling the RFID communications by the UE.

4. The apparatus of claim 1, wherein the one or more processors, to cause the UE to disable the RFID communications by the UE, are configured to cause the UE to provide, to a modem of the UE, an indication to stop performing RFID communications while the inactivity timer is active.

5. The apparatus of claim 1, wherein the configuration information is associated with a plurality of inactivity timers, the plurality of inactivity timers including two or more of a maximum duration timer, a location-based timer, a cell-based timer, a stationary timer, or a movement timer.

6. The apparatus of claim 5, wherein two or more inactivity timers of the plurality of inactivity timers are active at the same time, and wherein disabling the RFID communications by the UE based at least in part on an expiration of the inactivity timer comprises disabling the RFID communications by the UE based at least in part on an expiration of a single inactivity timer of the two or more inactivity timers.

7. The apparatus of claim 5, wherein the one or more processors are further configured to cause the UE to:
identify a target location of the UE; and
perform at least one of:
initiate the maximum duration timer based at least in part on a current location of the UE being within a threshold distance of the target location of the UE; or
initiate the location-based timer based at least in part on the current location of the UE being outside of the threshold distance of the target location of the UE,
wherein a duration of the maximum duration timer is greater than a duration of the location-based timer.

8. The apparatus of claim 7, wherein the one or more processors are further configured to cause the UE to store a plurality of global positioning system (GPS) coordinates corresponding to one or more locations where RFID communications are enabled or one or more locations where RFID operations have been performed by the UE, wherein the target location of the UE corresponds to at least one GPS coordinate of the plurality of GPS coordinates or corresponds to an area that is based at least in part on the plurality of GPS coordinates.

9. The apparatus of claim 7, wherein the one or more processors are further configured to cause the UE to:
detect, after initiating the location-based timer, that the UE has moved within the threshold distance of the target location of the UE;
deactivate the location-based timer; and
start the maximum duration timer.

10. The apparatus of claim 7, wherein the one or more processors are further configured to cause the UE to:
detect, after initiating the maximum duration timer, that the UE has moved outside of the threshold distance of the target location of the UE; and
start the location-based timer.

11. The apparatus of claim 5, wherein the one or more processors are further configured to cause the UE to:
identify one or more cell identifiers or one or more basic service set identifiers corresponding to one or more cells associated with the UE; and
perform at least one of:
initiate the maximum duration timer based at least in part on the UE being located within the one or more cells; or
initiate the cell-based timer based at least in part on the UE not being located within the one or more cells,
wherein a duration of the maximum duration timer is greater than a duration of the cell-based timer.

12. The apparatus of claim 11, wherein the one or more processors are further configured to cause the UE to store the one or more cell identifiers or the one or more basic service set identifiers corresponding to the one or more cells associated with the UE, wherein each cell of the one or more cells associated with the UE corresponds to a cell in which RFID communications are enabled or a cell in which RFID operations have been performed by the UE.

13. The apparatus of claim 11, wherein the one or more processors are further configured to cause the UE to:
detect, after initiating the cell-based timer, that the UE has moved to a location that is within the one or more cells;
deactivate the cell-based timer; and
start the maximum duration timer.

14. The apparatus of claim 11, wherein the one or more processors are further configured to cause the UE to:
detect, after initiating the maximum duration timer, that the UE has moved to a location that is outside of the one or more cells; and
start the cell-based timer.

15. The apparatus of claim 5, wherein the one or more processors are further configured to cause the UE to:
identify whether the UE is stationary; and
perform at least one of:
initiate the stationary timer based at least in part on the UE being stationary; or
initiate the movement timer based at least in part on the UE not being stationary,
wherein a duration of the stationary timer is greater than a duration of the movement timer.

16. The apparatus of claim 15, wherein the stationary timer or the movement timer is initiated based at least in part on global positioning information or cell-based information not being available to the UE.

17. The apparatus of claim 15, wherein the one or more processors, to cause the UE to identify whether the UE is stationary, are configured to cause the UE to use a step counter or one or more sensors associated with the UE.

18. The apparatus of claim 1, wherein the inactivity timer has a first duration in accordance with the UE being configured to perform wireless local area network communications and wireless wide area network communications or has a second duration in accordance with the UE being configured to perform wireless local area network communications and not being configured to perform wireless wide area network communications, the second duration being longer than the first duration.

19. A method of wireless communication performed by a user equipment (UE), comprising:
obtaining configuration information associated with an inactivity timer for radio frequency identification (RFID) communications, the configuration information indicating that the inactivity timer is to be stopped in accordance with an RFID operation being initiated and that the inactivity timer is to be restarted in accordance with the RFID operation being completed;
starting the inactivity timer based at least in part on executing an RFID application associated with performing the RFID communications; and
disabling the RFID communications by the UE based at least in part on an expiration of the inactivity timer.

20. A non-transitory computer-readable medium storing a set of instructions for wireless communication, the set of instructions comprising:
one or more instructions that, when executed by one or more processors of a user equipment (UE), cause the UE to:
obtain configuration information associated with an inactivity timer for radio frequency identification (RFID) communications, the configuration information indicating that the inactivity timer is to be stopped in accordance with an RFID operation being initiated and that the inactivity timer is to be restarted in accordance with the RFID operation being completed;
start the inactivity timer based at least in part on executing an RFID application associated with performing the RFID communications; and
disable the RFID communications by the UE based at least in part on an expiration of the inactivity timer.
